(19) United States
(12) Patent Application Publication
(10) Pub. No.: US 2019/0017874 A1
(43) Pub. Date: Jan. 17, 2019

(54) KEYBOARD CIRCUIT BOARD TESTING SYSTEM

(71) Applicant: Primax Electronics Ltd., Taipei (TW)

(72) Inventors: CHENG-YI TSAI, Taipei (TW); YING-CHE TSENG, Taipei (TW)

(21) Appl. No.: 15/834,861

(22) Filed: Dec. 7, 2017

(30) Foreign Application Priority Data
Jul. 14, 2017 (TW) 106123678

(51) Int. Cl. G01J 3/50; G01M 99/00

(52) U.S. Cl. CPC G01J 3/505; G01M 99/008

(57) ABSTRACT

A testing system is provided for testing a keyboard circuit board. The keyboard circuit board includes plural light emitters and plural light receivers. The keyboard circuit board testing system includes a first fixture, a second fixture and a computing device. The first fixture includes plural first recesses. The plural light emitters and the plural light receivers are accommodated within the first recesses. The second fixture includes plural test switches. The computing device is electrically connected with the keyboard circuit board, and executes a test program. The keyboard circuit board is clamped between the first fixture and the second fixture. The test program controls the plural light emitters to emit light beams to the corresponding light receivers. The test switches selectively interrupt or conduct optical paths of the light beams. The test program measures voltage changes of the light receivers, and generates a test record.

### FIELD OF THE INVENTION

The present invention relates to a testing system for an input device, and more particularly to a testing system for an optical keyboard.

### BACKGROUND OF THE INVENTION

With increasing development of science and technology, the computers are widely and deeply applied to all families and all industries. As known, an input device is an essential device for operating the computer. There are many kinds of computer input devices to be selected. Generally, keyboards and mouse devices are the widely-used computer input devices.

Conventionally, the keyboards are classified into some types, including mechanical keyboards, membrane keyboards, conductive rubber keyboards and contactless electrostatic capacitive keyboards. For meeting the needs of different users, the keyboard is designed to have slime appearance and comply with the ergonomic demand. Moreover, the keyboard is usually equipped with various function modules. For example, the function modules include a Bluetooth wireless function module, a backlight prompt module, a USB connection module, an audio output/input function module, and so on. For increasing the sensitivity of pressing the keys, an optical interrupter module is used as a key-press triggering mechanism of the keyboard in recent years.

However, the keyboard with the optical interrupter module as the switch cannot be tested by the conventional testing tool. Therefore, there is a need of providing a keyboard circuit board testing system for testing the optical interrupter module in order to increase the yield of the keyboard.

### SUMMARY OF THE INVENTION

An object of the present invention provides a keyboard circuit board testing system for testing an optical interrupter module and testing whether a backlight source of the keyboard circuit board is normally operated.

In accordance with an aspect of the present invention, there is provided a keyboard circuit board testing system for testing a keyboard circuit board. The keyboard circuit board includes plural light emitters and plural corresponding light receivers. The keyboard circuit board testing system includes a first fixture, a second fixture and a computing device. The first fixture includes plural first recesses. The plural light emitters and the plural light receivers are accommodated within the corresponding first recesses. The second fixture includes plural test switches. The computing device is electrically connected with the keyboard circuit board, and executes a test program. The keyboard circuit board is clamped between the first fixture and the second fixture. The test program controls the plural light emitters to emit light beams to the corresponding light receivers. The test switches selectively interrupt or conduct optical paths of the corresponding light beams. The test program measures voltage changes of the plural light receivers, and generates a test record corresponding to the keyboard circuit board.

In an embodiment, the keyboard circuit board testing system further comprises a pressing plate with plural pressing blocks. The plural test switches are pressed by the corresponding pressing blocks of the pressing plate.

In an embodiment, the keyboard circuit board further includes plural backlight units, and the second fixture comprises plural light-collecting holes. The plural backlight units are received in and covered by the corresponding light-collecting holes.

In an embodiment, plural light-collecting units are accommodated within the corresponding light-collecting holes, and light beams emitted by the plural backlight units are concentrated by the corresponding light-collecting units.

In an embodiment, the keyboard circuit board testing system further includes an image pickup module. The test program controls illumination of the plural backlight units and controls the image pickup module to capture an optical image of the concentrated light beams from the light-collecting units.

In an embodiment, the test program performs chromaticity comparison on the optical image and generates the test record according to a result of the chromaticity comparison.

In an embodiment, the computing device includes a display device, and a test interface of the test program is shown on the display device.

In an embodiment, the test interface includes a keyboard press test interface and a backlight source test interface.

In an embodiment, the keyboard circuit board testing system further includes a cloud server. The test record is transmitted from the test program to a database of the cloud server in a wired transmission manner or a wireless transmission manner and stored in the database.

In an embodiment, the keyboard circuit board testing system further includes a label printer. The test program controls the label printer to print a barcode label. The barcode label contains an information about the test record corresponding to the keyboard circuit board.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A schematically illustrates the concepts of a keyboard circuit board testing system according to an embodiment of the present invention;

FIG. 1B schematically illustrates a situation of testing the pressing actions on the keyboard by the keyboard circuit board testing system of FIG. 1A;

FIGS. 2A and 2B are cross-sectional views illustrating a first exemplary mechanism for testing the pressing actions on the keyboard by using the keyboard circuit board testing system of the present invention;

FIGS. 3A, 3B and 3C are cross-sectional views illustrating a second exemplary mechanism for testing the pressing actions on the keyboard by using the keyboard circuit board testing system of the present invention;

FIG. 4 is a cross-sectional view illustrating a mechanism for testing the backlight source by using the keyboard circuit board testing system of the present invention; and

FIG. 5 schematically illustrates a test interface of the keyboard circuit board testing system according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

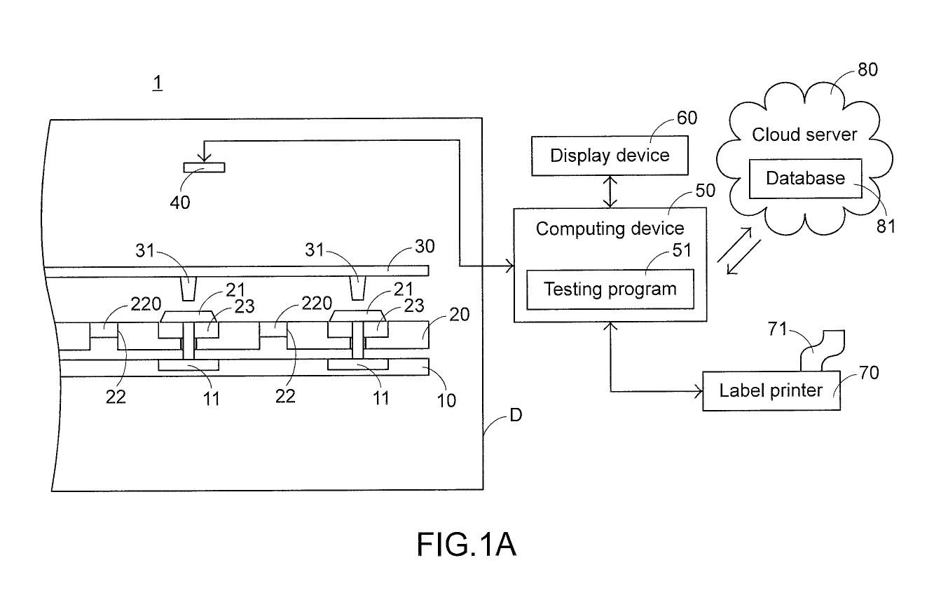

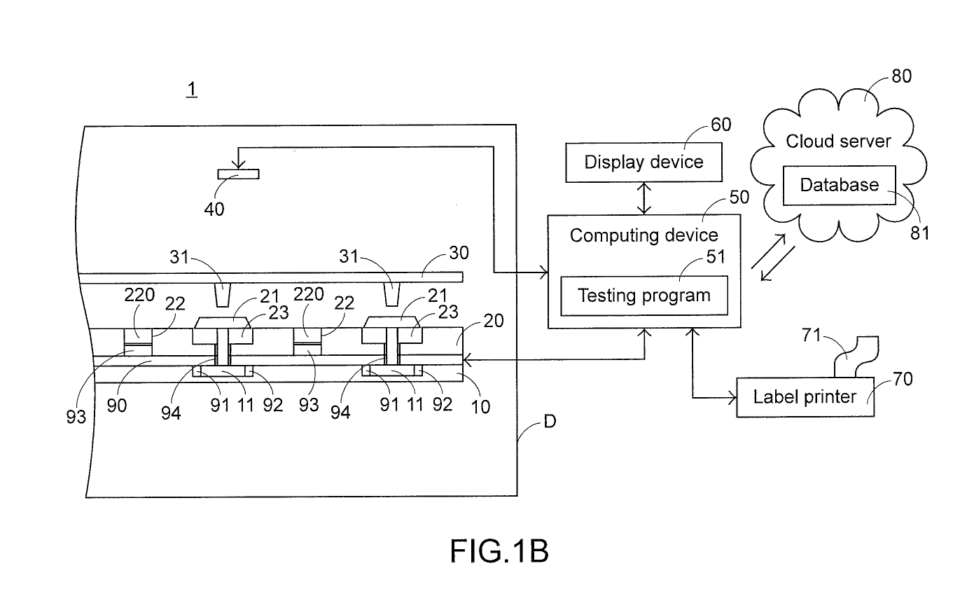

FIG. 1A schematically illustrates the concepts of a keyboard circuit board testing system according to an embodiment of the present invention. As shown in FIG. 1A, the keyboard circuit board testing system 1 comprises a first fixture 10, a second fixture 20, a pressing plate 30, an image pickup module 40, a computing device 50, a display device 60, a label printer 70, a cloud server 80 and a dark box D. The computing device 50 is electrically connected with the image pickup module 40, the display device 60 and the label printer 70. The first fixture 10 comprises plural first recesses 11. The second fixture 20 comprises plural light-collecting holes 22 and plural second recesses 23. A light-collecting unit 220 is accommodated within the corresponding light-collecting hole 22. For example, the light-collecting unit 220 is an optical fiber or a collecting lens. Moreover, plural test switches 21 for simulating the key-pressing actions are accommodated within the corresponding second recesses 23. The pressing plate 30 is located over the second fixture 20. Moreover, plural pressing blocks 31 for pressing the test switches 21 are formed on a surface of the pressing plate 30. Moreover, a test program 51 is stored in and executed by the computing device 50. The first fixture 10, the second fixture 20, the pressing plate 30 and the image pickup module 40 are accommodated within the dark box D. The dark box D is used for isolating the ambient light. Consequently, the under-test electronic device is not interfered by the ambient light.

FIG. 1B schematically illustrates a situation of testing the pressing actions on the keyboard by the keyboard circuit board testing system of FIG. 1A. As shown in FIG. 1B, a keyboard circuit board 90 is electrically connected with the computing device 50 at first. Consequently, the test program 51 is capable of controlling and testing the operations of the keyboard circuit board 90. Moreover, plural light emitters 91 for triggering keys signals and plural corresponding light receivers 92 are disposed on a first surface of the keyboard circuit board 90. For example, the light emitters 91 on the keyboard circuit board 90 are light emitting diodes (LED), and the light receivers 92 on the keyboard circuit board 90 are opto-transistors or photoresistors. Moreover, plural backlight units 93 for illuminating keys are disposed on a second surface of the keyboard circuit board 90.

Firstly, the keyboard circuit board 90 is manually or automatically placed on the first fixture 10. The light emitters 91 and the light receivers 92 are accommodated within the corresponding first recesses 11. Consequently, the light emitters 91 and the light receivers 92 are placed in the sealed spaces that are not interfered by the surroundings. The test program 51 of the computing device 50 controls the light emitters 91 to emit light beams to the corresponding light receivers 92. Then, the second fixture 20 is manually or automatically placed on the keyboard circuit board 90. Consequently, the keyboard circuit board 90 is clamped between the first fixture 10 and the second fixture 20. The second recesses 23 of the second fixture 20 are aligned with the first recesses 11 of the first fixture 10. Consequently, the test switches 21 can be selectively operated to interrupt or conduct the optical paths between the light emitters 91 and the corresponding light receivers 92. Then, the test program 51 of the computing device 50 measures the voltage changes of the light receivers 92. Moreover, the backlight units 93 are received in and covered by the corresponding light-collecting holes 22 of the second fixture 20.

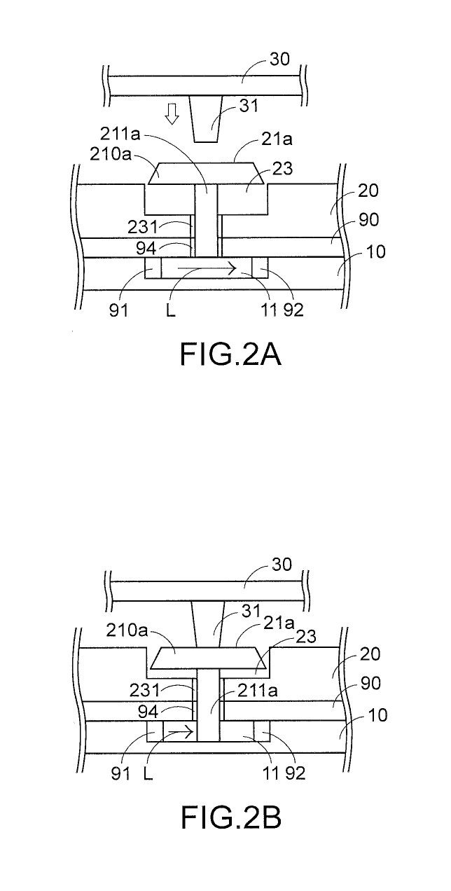

FIGS. 2A and 2B are cross-sectional views illustrating a first exemplary mechanism for testing the pressing actions on the keyboard by using the keyboard circuit board testing system of the present invention. As shown in FIG. 2A, the test switch 21a comprises a switch keycap 210a and a test post 211a. Moreover, a test hole 231 is formed in the second recess 23. The keyboard circuit board 90 comprises plural key holes 94. The test hole 231 is aligned with the corresponding key hole 94. Consequently, the test post 211a of the test switch 21a can be penetrated through the test hole 231 and the key hole 94 simultaneously. Moreover, an elastic element (not shown) is disposed within the second recess 23 for returning the test switch 21a to its original position. Consequently, the test switch 21a is movable within the second recess 23 upwardly or downwardly. Then, the pressing plate 30 is manually or automatically controlled. Consequently, the switch keycap 210a of the test switch 21a is pressed by the pressing block 31 of the pressing plate 30.

Please refer to FIG. 2A again. Before the pressing block 31 of the pressing plate 30 is moved downwardly, the test switch 21a simulates the undepressed state of the key of the keyboard. Under this circumstance, the light beam L emitted by the light emitter 91 under control of the test program 51 can be received by the corresponding light receiver 92.

Please refer to FIG. 2B. As the pressing block 31 of the pressing plate 30 is moved downwardly, the test post 211a of the test switch 21a is penetrated through the key hole 94 of the keyboard circuit board 90 and protruded to the region between the light emitter 91 and the light receiver 92. Meanwhile, the test switch 21a simulates the depressed state of the key of the keyboard. Under this circumstance, the light beam L emitted by the light emitter 91 is interrupted by the test post 211a. Consequently, the light beam L cannot be received by the light receiver 92.

In case that the light beam L is not interrupted by the test post 211a, the light receiver 92 has a first voltage. In case that the light beam L is interrupted by the test post 211a, the light receiver 92 has a second voltage. Then, the test program 51 of the computing device 50 calculates the voltage change of the light receiver 92, i.e., the difference between the first voltage and the second voltage. According to the voltage change of the light receiver 92, the computing device 50 judges whether the light emitter 91 and the light receiver 92 are normally operated. According to the testing result, the computing device 50 generates a test record.

Moreover, the level of pressing the switch keycap 210a by the pressing block 31 of the pressing plate 30 can be manually or automatically adjusted. Consequently, the level of interrupting the optical path of the light beam L by the test post 211a can be corresponding adjusted. For example, when the optical path of the light beam L is not interrupted by the test post 211a, the test program 51 measures the voltage value of the light receiver 92 and judges whether the light receiver 92 is qualified. Then, the test post 211a is moved downwardly to interrupt one-fourth of the optical path of the light beam L. Similarly, the test program 51 measures the voltage value of the light receiver 92 and judges whether the light receiver 92 is qualified. Then, the test post 211a is moved downwardly to interrupt one half of the optical path of the light beam L. Similarly, the test program 51 measures the voltage value of the light receiver 92 and judges whether the light receiver 92 is qualified. Then, the test post 211a is moved downwardly to interrupt three-fourths of the optical path of the light beam L. Similarly, the test program 51 measures the voltage value of the light receiver 92 and judges whether the light receiver 92 is qualified. The voltage values measured in the above steps are used as the basis of calibrating the key movable range of the keyboard circuit board 90 by the test program 51. Moreover, the measured voltage values are written into a microcontroller (MCU, not shown) of the keyboard circuit board 90.

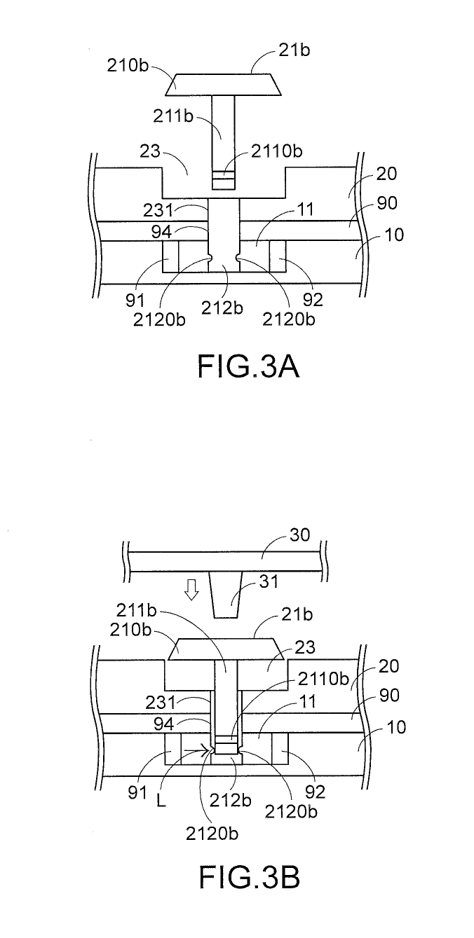

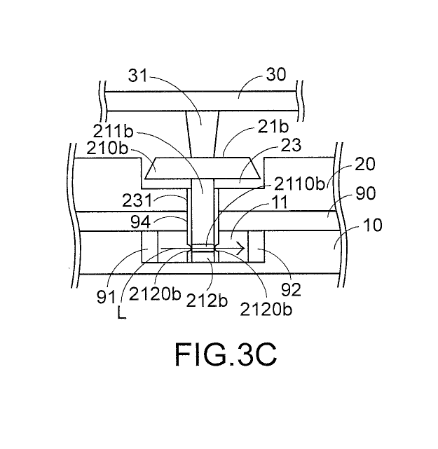

FIGS. 3A, 3B and 3C are cross-sectional views illustrating a second exemplary mechanism for testing the pressing actions on the keyboard by using the keyboard circuit board testing system of the present invention. As shown in FIG. 3A, the test switch 21b comprises a switch keycap 210b, a test post 211b and a sleeve 212b. The test post 211b comprises a first light-transmissible hole 2110b for allowing the light beam to pass through. The sleeve 212b is fixed in the test hole 231 and penetrated through the key hole 94. Moreover, a first end of the sleeve 212b is protruded to the region between the light emitter 91 and the light receiver 92. The sleeve 212b is a hollow structure for accommodating the test post 211b. Moreover, the first end of the sleeve 212b comprises two second light-transmissible holes 2120b, which are opposed to each other.

As shown in FIG. 3B, the test post 211b of the test switch 21b is received within the sleeve 212b. Moreover, an elastic element (not shown) is disposed within the second recess 23 for returning the test switch 21b to its original position. Consequently, the test switch 21b is movable within the second recess 23 upwardly or downwardly. Moreover, the switch keycap 210b of the test switch 21b can be pressed by the pressing block 31 of the pressing plate 30.

Please refer to FIG. 3B again. Before the pressing block 31 of the pressing plate 30 is moved downwardly, the test switch 21b simulates the undepressed state of the key of the keyboard. Under this circumstance, the light beam L emitted by the light emitter 91 under control of the test program 51 is penetrated through the second light-transmissible holes 2120b but interrupted by the test post 211b. Consequently, the light beam L cannot be received by the light receiver 92.

Please refer to FIG. 3C. As the pressing block 31 of the pressing plate 30 is moved downwardly, the test post 211b simulates the depressed state of the key of the keyboard. When the test post 211b is moved downwardly and the first light-transmissible hole 2110b of the test post 211b is aligned with the second light-transmissible holes 2120b, the light beam L from the light emitter 91 is not interrupted. Consequently, the light beam L is transmitted through the second light-transmissible holes 2120b (near the light emitter 91), the first light-transmissible hole 2110b and the other second light-transmissible holes 2120b (near the light receiver 92) sequentially. Under this circumstance, the light beam L can be received by the light receiver 92.

In case that the light beam L is not interrupted by the test post 211b, the light receiver 92 has a first voltage. In case that the light beam L is interrupted by the test post 211b, the light receiver 92 has a second voltage. Then, the test program 51 of the computing device 50 calculates the voltage change of the light receiver 92, i.e., the difference between the first voltage and the second voltage. According to the voltage change of the light receiver 92, the computing device 50 judges whether the light emitter 91 and the light receiver 92 are normally operated. According to the testing result, the computing device 50 generates a test record.

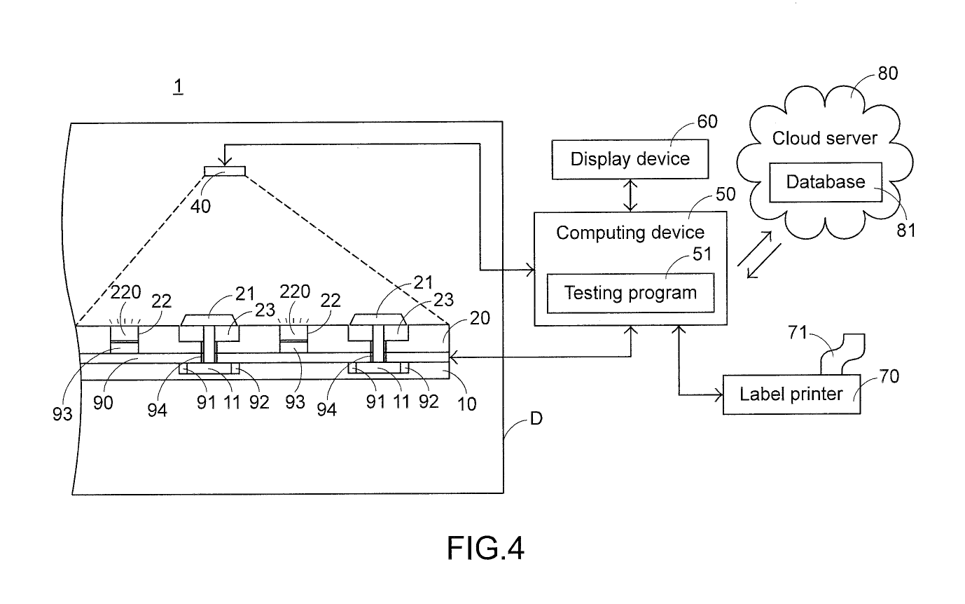

FIG. 4 is a cross-sectional view illustrating a mechanism for testing the backlight source by using the keyboard circuit board testing system of the present invention. After the process of testing the pressing actions on the keyboard is completed, the pressing plate 30 is manually or automatically removed. In response to the elasticity of the elastic element, the test switch 21 is returned to its original position. Meanwhile, the test switch 21 is restored to the undepressed state. Then, the test program 51 of the computing device 50 controls one or plural backlight units 93 to emit light beams. The light beams from the backlight units 93 are concentrated by the light-collecting units 220. Then, the test program 51 controls the image pickup module 40 to capture an optical image of the light beams from the light-collecting units 220 and performs chromaticity comparison on the captured optical image of the light beams. After the process of testing the pressing actions on the keyboard and the process of testing the backlight source are completed, the second fixture 20 is manually or automatically removed and the keyboard circuit board 90 is manually or automatically removed from the first fixture 10.

Please refer to FIG. 4 again. The process of testing the backlight source will be described as follows. For example, the backlight unit 93 is a RGB LED module. Firstly, the test program 51 controls one or plural backlight units 93 to emit red light beams. Then, the image pickup module 40 captures the optical image of the red light beams from the one or plural backlight units 93. Moreover, the information about a standard red chromaticity is stored in the test program 51. Then, the test program 51 compares the captured optical image of the red light beams with the standard red chromaticity, and judges whether the light beams from the one or plural backlight units 93 comply with the standard red chromaticity according to the comparing result. Then, the test program 51 controls one or plural backlight units 93 to emit green light beams. Then, the image pickup module 40 captures the optical image of the green light beams from light-collecting units 220. Similarly, the information about a standard green chromaticity is stored in the test program 51. Then, the test program 51 compares the captured optical image of the green light beams with the standard green chromaticity, and judges whether the light beams from the one or plural backlight units 93 comply with the standard green chromaticity according to the comparing result. Then, the test program 51 controls one or plural backlight units 93 to emit blue light beams. Then, the image pickup module 40 captures the optical image of the blue light beams from light-collecting units 220. Similarly, the information about a standard blue chromaticity is stored in the test program 51. Then, the test program 51 compares the captured optical image of the blue light beams with the standard blue chromaticity, and judges whether the light beams from the one or plural backlight units 93 comply with the standard blue chromaticity according to the comparing result. Then, the test program 51 controls one or plural backlight units 93 to emit white light beams. Then, the image pickup module 40 captures the optical image of the white light beams from light-collecting units 220. Similarly, the information about a standard white chromaticity is stored in the test program 51. Then, the test program 51 compares the captured optical image of the white light beams with the standard white chromaticity, and judges whether the light beams from the one or plural backlight units 93 comply with the standard white chromaticity according to the comparing result. After the test program 51 judges that all of the backlight units 93 are normal, a test record is generated according to the test result. Moreover, the test program 51 may calibrate the chromaticity of the backlight units 93 according to the test result of the backlight unit 93.

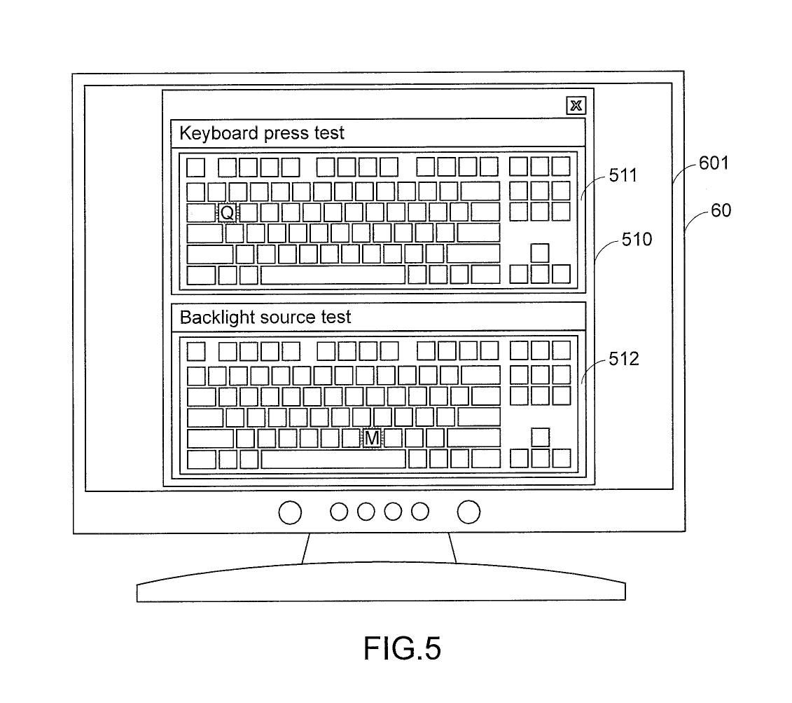

Please refer to FIGS. 2A, 2B, 3A, 3B, 3C, 4 and 5. FIG. 5 schematically illustrates a test interface of the keyboard circuit board testing system according to an embodiment of the present invention. As shown in FIG. 5, the display device 60 comprises a display screen 601. A test interface 510 of the test program 51 is shown on the display screen 601. The test interface 510 comprises a keyboard press test interface 511 and a backlight source test interface 512. The results of testing the pressing actions on the keyboard (e.g., the examples of FIGS. 2A, 2B, 3A, 3B, 3C) are shown on the keyboard press test interface 511. The results of testing the backlight source of the keyboard is shown on the backlight source test interface 512 (see FIG. 4).

Please refer to FIG. 5 again. If the pressing action on any key of the keyboard is abnormal or any key is unqualified, the position of the key that is abnormally pressed or unqualified is shown on the keyboard press test interface 511. For example, if the key “Q” cannot be normally operated, the position of the key “Q” on the keyboard press test interface 511 is highlighted to prompt the tester. According to the message shown on the display screen 601, the tester on the production line realizes that the key “Q” cannot be normally operated. Please refer to FIG. 5 again. If the backlight source corresponding to any key of the keyboard cannot be normally operated, the position of the key that is not normally illuminated is shown on the backlight source test interface 512. For example, if the backlight unit 93 corresponding to the key “M” cannot be normally illuminated, the position of the key “M” on the backlight source test interface 512 is highlighted to prompt the tester. According to the message shown on the display screen 601, the tester on the production line realizes that the backlight source of the key “M” cannot be normally illuminated.

Please refer to FIG. 5 again. For example, the backlight unit 93 corresponding to key “M” is a RGB LED module. If the red light source of the LED module cannot be normally operated, the position of the key “M” on the backlight source test interface 512 is highlighted with a red color to prompt the tester. If the green light source of the LED module cannot be normally operated, the position of the key “M” on the backlight source test interface 512 is highlighted with a green color to prompt the tester. If the blue light source of the LED module cannot be normally operated, the position of the key “M” on the backlight source test interface 512 is highlighted with a blue color to prompt the tester. If the red light source and the green light source of the LED module cannot be normally operated, the position of the key “M” on the backlight source test interface 512 is highlighted with a yellow color to prompt the tester. If the red light source and the blue light source of the LED module cannot be normally operated, the position of the key “M” on the backlight source test interface 512 is highlighted with a purple color to prompt the tester. If the blue light source and the green light source of the LED module cannot be normally operated, the position of the key “M” on the backlight source test interface 512 is highlighted with a cyan color to prompt the tester. If the red light source, the green light source and the blue light source of the LED module cannot be normally operated, the position of the key “M” on the backlight source test interface 512 is highlighted with a black color to prompt the tester.

Please refer to FIGS. 1B and 4. The test record of the keyboard press test and the test record of the backlight source test are transmitted from the test program 51 of the computing device 50 to a database 81 of the cloud server 80 in a wired transmission manner or a wireless transmission manner and stored in the database 81. The maintenance worker of the next maintenance station on the production line can download the test records of the keyboard circuit board 90 from the database 81 of the cloud server 80. According to the test records, the maintenance worker performs the subsequent maintenance process or the subsequent assembling process. As mentioned above, the label printer 70 is electrically connected with the computing device 50. In an embodiment, the test program 51 of the computing device 50 controls the label printer 70 to print a barcode label 71, which contains the information about the test record. Then, the tester on the production line may attach the barcode label 71 on the keyboard circuit board 90. After the maintenance worker of the next maintenance station on the production line uses a scanner to scan the barcode label 71, the test record about the keyboard circuit board 90 is acquired. According to the test records, the maintenance worker performs the subsequent maintenance process or the subsequent assembling process more quickly.

From the above descriptions, the present invention provides a keyboard circuit board testing system. The keyboard circuit board testing system is capable of performing a keyboard press test and a backlight source test. In other words, the technology of the present invention is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A keyboard circuit board testing system for testing a keyboard circuit board, the keyboard circuit board comprising plural light emitters and plural corresponding light receivers, the keyboard circuit board testing system comprising:
a first fixture comprising plural first recesses, wherein the plural light emitters and the plural light receivers are accommodated within the corresponding first recesses;
a second fixture comprising plural test switches; and
a computing device electrically connected with the keyboard circuit board, and executing a test program,
wherein the keyboard circuit board is clamped between the first fixture and the second fixture, the test program controls the plural light emitters to emit light beams to the corresponding light receivers, the test switches selectively interrupt or conduct optical paths of the light beams from the corresponding light emitters, the test program measures voltage changes of the plural light receivers, and the test program generates a test record corresponding to the keyboard circuit board.

2. The keyboard circuit board testing system according to claim 1, further comprising a pressing plate with plural pressing blocks, wherein the plural test switches are pressed by the corresponding pressing blocks of the pressing plate.

3. The keyboard circuit board testing system according to claim 1, wherein the keyboard circuit board further comprises plural backlight units, and the second fixture comprises plural light-collecting holes, wherein the plural backlight units are received in and covered by the corresponding light-collecting holes.

4. The keyboard circuit board testing system according to claim 3, wherein plural light-collecting units are accommodated within the corresponding light-collecting holes, and light beams emitted by the plural backlight units are concentrated by the corresponding light-collecting units.

5. The keyboard circuit board testing system according to claim 4, further comprising an image pickup module, wherein the test program controls illumination of the plural backlight units and controls the image pickup module to capture an optical image of the concentrated light beams from the light-collecting units.

6. The keyboard circuit board testing system according to claim 5, wherein the test program performs chromaticity comparison on the optical image and generates the test record according to a result of the chromaticity comparison.

7. The keyboard circuit board testing system according to claim 1, wherein the computing device comprises a display device, and a test interface of the test program is shown on the display device.

8. The keyboard circuit board testing system according to claim 7, wherein the test interface comprises a keyboard press test interface and a backlight source test interface.

9. The keyboard circuit board testing system according to claim 1, further comprising a cloud server, wherein the test record is transmitted from the test program to a database of the cloud server in a wired transmission manner or a wireless transmission manner and stored in the database.

10. The keyboard circuit board testing system according to claim 1, further comprising a label printer, wherein the test program controls the label printer to print a barcode label, and the barcode label contains an information about the test record corresponding to the keyboard circuit board.
